(19) United States
(12) Patent Application Publication
(10) Pub. No.: US 2006/0290258 A1
(43) Pub. Date: Dec. 28, 2006

(54) Gas discharge lamp with down conversion phosphor

(75) Inventors: Claus Feldmann, Ettlingen (DE); Maya Doytcheva, Eindhoven (NL); Andries Meijerink, Soesterberg (NL)

Correspondence Address: PHILIPS INTELLECTUAL PROPERTY & STANDARDS, P.O. BOX 3001, BRIARCLIFF MANOR, NY, 10510, US

(73) Assignee: Koninklike Philips Electronics, N.V., Eindhoven (NL)

(21) Appl. No.: 10/569,183

(22) PCT Filed: Aug. 16, 2004
(86) PCT No.: PCT/IB04/51462

§ 371 Date: Feb. 22, 2006

(30) Foreign Application Priority Data
Aug. 27, 2003 (EP) 03102662.8

(51) Int. Cl. H01J 1/62; H01J 63/04

(52) U.S. Cl. 313/483; 313/485; 313/487

(57) ABSTRACT

A gas discharge lamp fitted with a gas discharge vessel filled with a gas filling suitable for a gas discharge which emits VUV radiation, with a phosphor coating containing a down-conversion phosphor and with means for igniting and maintaining a gas discharge, in which the down-conversion phosphor has, in a host lattice, a pair of activators of a first lanthanoid ion and a second lanthanoid ion and a sensitizer selected from the group formed by the thallium(I) ion and lead(II) ion, is environmentally friendly and has a high lamp efficiency (lamp. The invention also relates to a down-conversion phosphor comprising, in a host lattice, a pair of activators of a first lanthanoid ion and a second lanthanoid ion and a sensitizer selected from the group formed by the thallium(I) ion and lead(II) ion, wherein the sensitizer occupies a crystallographic site with a coordination number C.N.≧10.

The invention relates to a gas discharge lamp fitted with a gas discharge vessel filled with a gas suitable for supporting a gas discharge emitting VUV radiation, with a phosphor coating containing a down conversion phosphor and with means for igniting and maintaining a gas discharge.

Conventional fluorescent lamps are mercury gas discharge lamps, the light emission of which is based on a mercury low-pressure gas discharge. A mercury low-pressure gas discharge emits radiation mainly in the near UV with a maximum at approximately 254 nm, which is converted into visible light by UV-phosphors.

The mercury gas discharge lamp has a refined technology and, with regard to the lamp efficiency ρₗₐₘₚ, can only be matched or exceeded with difficulty by other lamp technologies. The mercury in the gas filling is, however, increasingly regarded as an environmentally harmful and toxic substance, which should be avoided as far as possible in modern mass production because of environmental risks in use, production and disposal.

Therefore, for some time efforts have been concentrated on the development of alternative lamp technologies.

One of the mercury-free or low-mercury alternatives to the conventional mercury gas discharge lamp is the xenon low-pressure gas discharge lamp, which has a gas filling containing mainly xenon. A gas discharge in a xenon low-pressure gas discharge lamp emits vacuum ultraviolet radiation (VUV radiation) in contrast to the UV radiation of the mercury discharge. The VUV radiation is generated by excimers, for example Xe₂*, and is a molecular band radiation with a broad spectrum with a maximum in the range about 172 nm. Using this lamp technology, discharge efficiencies ρ_{dis} of 65% have been already achieved.

Another advantage of the xenon low-pressure gas discharge lamp is the short response time of the gas discharge, which makes it useful as a signal lamp for automobiles, as a lamp for copier and fax devices and as a water disinfection lamp.

However, although the xenon low-pressure gas discharge lamp achieves a discharge efficiency ρ_{dis}, this which is comparable to that of the mercury gas discharge lamp, the lamp efficiency ρₗₐₘₚ, of the xenon low-pressure gas discharge lamp is still clearly below that of the mercury gas discharge lamp.

In principles the ρₗₐₘₚ efficiency ρₗₐₘₚ consists of the components discharge efficiency ρ_{dis} phosphor efficiency ρₚₕₒₛ, the proportion of the generated visible light which leaves the lamp ρ_{esc} and the proportion ρᵥᵤᵥ of UV radiation generated by the phosphor:
ρₗₐₘₚ=ρ_{dis}·ρₚₕₒₛ·ρ_{esc}·ρᵥᵤᵥ

A handicap of the conventional xenon low-pressure gas discharge lamp is inherent in the conversion of an energy-rich VUV photon with a wavelength of around 172 nm to a comparatively low-energy photon with a wavelength in the visible spectrum of 400 nm to 700 nm through the phosphor coating of the lamp. This conversion is ineffective in principle. Even if the quantum efficiency of the phosphor is close to 100%, by conversion of a VUV photon to a visible photon, on average 65% of the energy is lost due to non-radiative transitions.

Surprisingly, however, it has already been possible to develop VUV phosphors, which achieve a quantum efficiency of more than 100% for the conversion of VUV photons to visible photons. This quantum efficiency is achieved in that a VUV quantum with electron energy of 7.3 eV is converted to two visible quanta with electron energy of approximately 2.5 eV. Such phosphors for xenon low-pressure gas discharge lamps are known from, for example, Rene T. Wegh, Harry Donker, Koentraad D. Oskam, Andries Meijerink “Visible Quantum Cutting in LiGdF₄:Eu³⁺ through Down-conversion” Science 283, 663.

In analogy to the multi-photon phosphors already known for some time, which through “up-conversion” generate one short-wave photon from two visible long-wave photons, these new phosphors, which generate two long-wave photons from one short-wave photon, are known as down-conversion phosphors.

However, although the quantum efficiency of the known down-conversion phosphors is high, this does not mean that also the phosphor efficiency ηₚₕₒₛ is high too. The phosphor efficiency ηₚₕₒₛ is not only determined by the quantum efficiency but also by the capability of the phosphor to absorb the VUV radiation to be converted. The absorptivity of the known down-conversion phosphor, however, is very poor. Too much energy is lost due to undesirable adsorptions in the lattice and hence the occupation of the excited states is reduced.

From WO 2002097859 an down-conversion phosphor comprising, in a host lattice, a pair of activators of a first lanthanoid ion and a second lanthanoid ion and a sensitizer selected from the group formed by the thallium(I) ion, and lead(II) ion with improved absorptivity is known.

Yet though the phosphors according to WO 2002097859 showed improved absorptivity, this prior art phosphor still suffers from poor efficacy.

It is believed that the poor efficacy is caused by a back-transfer mechanism that occurs from the activator to the sensitizer and hinders the quantum cutting process.

It is therefore an object of the present invention to develop a gas discharge lamp fitted with a gas discharge vessel filled with a gas suitable for a gas discharge which emits VUV-radiation, with a phosphor coating which contains a down-conversion phosphor and with means for igniting and maintaining a gas discharge, the efficiency of which is improved.

In accordance with the invention, this object is achieved by a gas discharge lamp fitted with a gas discharge vessel filled with a gas filling suitable for supporting a gas discharge emitting VUV radiation, with a phosphor coating containing a down-conversion phosphor, and with means for igniting and maintaining a gas discharge, in which the down-conversion phosphor comprises in a host lattice with crystallographic sites a pair of activators of a first lanthanoid ion and a second lanthanoid ion and a sensitizer, selected from the group formed by the thallium(I) ion and lead(II) ion, wherein the sensitizer occupies a crystallographic site with a coordination number C.N.≧10.

Particularly advantageous effects in relation to the state of the art are obtained by the invention if the first lanthanoid ion is the gadolinium(III) ion and the second lanthanoid ion is selected from the holmium(III) ion and the europium(III) ion.

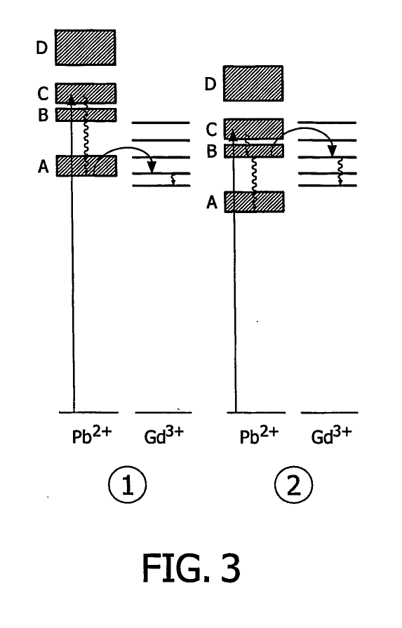

The main advantage of the phosphors according to the invention is best described in terms of the energy level diagram of FIG. 3, scheme 1.

For the sensitizer it is necessary to consider the excitation efficiency. The main factors, which influence the efficiency, are the excitation cross section of the sensitizer, concentration, the excitation mechanism and the sensitizer lifetime. To maximize the excitation efficiency, the sensitizer must have a large excitation cross-section and large doping concentration.

The excitation cross section is largely dependent on the excitation mechanism.

In a down-conversion phosphor with the Gd³⁺—Eu³⁺ or Gd³⁺—Ho³⁺ couple incorporated and Tl⁺ or Pb²⁺ located on a highly coordinated crystallographic site of a suitable host lattice Tl⁺ or Pb²⁺ can be excited with VUV light to the A-, B-, C- or D-band. After non-radiative decay to the A-band, energy is transferred to the ⁶G_{J}-level of Gd³⁺. Afterwards, the down-conversion process can occur. Altogether, an efficient absorption of VUV light, which is less wavelength depended compared to ⁸S_{7/2}-⁶G_{J} transition on Gd³⁺ as in the phosphors according to the state of the art, and also efficient energy transfer to the ⁶G_{J}-level of Gd³⁺ is realized.

Within the scope of the present invention it is preferred that the host lattice of the down-conversion phosphor is a fluoride.

In one aspect of the present invention the host lattice of the down-conversion phosphor is a perovskite.

In another aspect of the present invention the host lattice of the down-conversion phosphor is an elpasolite.

In one embodiment of the invention it is preferred, that the down-conversion phosphor comprises the gadolinium(III) ion as the first lanthanoid ion and as the second lanthanoid ion, the holmium(II) ion and a co-activator selected from the group formed by the terbium(III)ion, ytterbium(III) ion, dysprosium(III) ion, europium(III) ion, samarium(III) ion and manganese(II) ion.

It is preferred that the down-conversion phosphor contains the first lanthanoid ion in a concentration of 10.0 to 99.98 mol %, the second lanthanoid ion in a concentration of 0.01 to 30.0 mol % and the sensitizer in a concentration of 0.01 to 30.0 mol %.

It is particularly preferred, that the down-conversion phosphor contains the sensitizer in a concentration of 0.5 mol %.

It may alternatively be preferred, that the down-conversion phosphor contains the co-activator in a concentration of 0.01 to 30.0 mol %.

It is particularly preferred, that the down-conversion phosphor contains the co-activator in a concentration of 0.5 mol %.

The invention also relates to a down-conversion phosphor comprises in a host lattice with crystallographic sites a pair of activators of a first lanthanoid ion and a second lanthanoid ion and a sensitizer, selected from the group formed by the thallium(I) ion and lead(II) ion, wherein the sensitizer occupies a crystallographic site with a coordination number C.N.≧10.

The phosphor is characterized by high quantum efficiency, high absorption of VUV photons and, in addition, high chemical resistance, so that said phosphor is particularly suitable for commercial applications, also in plasma display screens. Such a phosphor can also advantageously be used for signal lamps in motor vehicles.

The invention is now described in more detail.

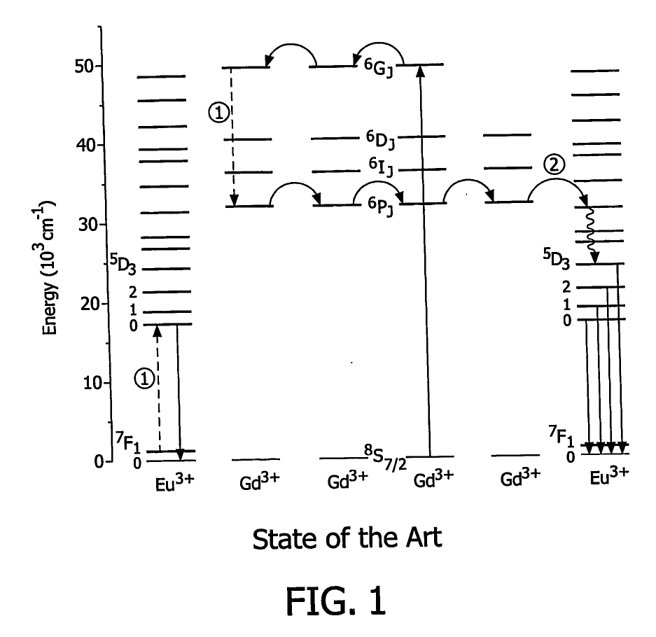

FIG. 1 contains information on a state of the art energy transfer mechanism based on the Gd³⁺—Eu³⁺ couple.

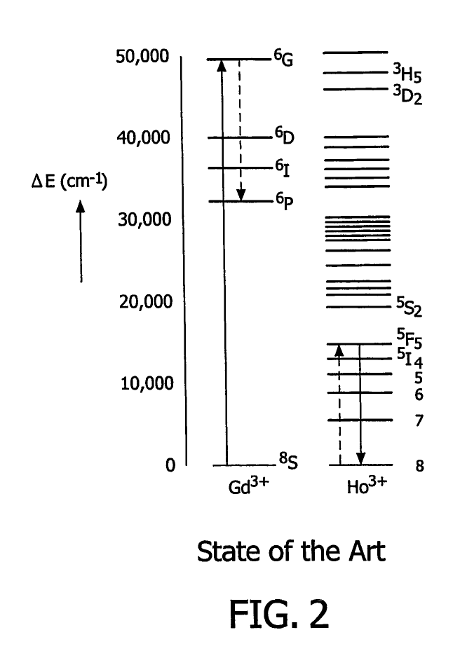

FIG. 2 contains information on a state of the art energy transfer mechanism based on the Gd³⁺—Ho³⁺ couple.

FIG. 3 contains information on the sensitization of Gd³⁺—Eu³⁺ and Gd³⁺—Ho³⁺ couple with s²-ions (e.g. Pb²⁺).

A gas discharge lamp according to the invention comprises a gas discharge vessel with a gas filling and with at least one wall having a surface that is at least partially transparent to visible radiation and that is provided with a phosphor layer. The phosphor layer contains a phosphor preparation with a down-conversion phosphor of an inorganic crystalline host lattice, which has obtained its luminous power from activation through an activator pair of a first and a second lanthanoid ion. The down-conversion phosphor is sensitized by a sensitizer selected from the group formed by the thallium (I) ion and lead (II). The sensitizer occupies a crystallographic site with a coordination number C.N.≧10. In addition, the gas discharge lamp is fitted with an electrode structure to ignite the gas discharge and with further means to ignite and maintain the gas discharge.

Preferably, the gas discharge lamp is a xenon low-pressure gas discharge lamp. Various types of xenon low-pressure gas discharge lamps are known which differ in the ignition of the gas discharge. The spectrum of the gas discharge first contains a high proportion of VUV radiation invisible to the human eye, which is converted into visible light in the coating of VUV phosphors on the inside of the gas discharge vessel and then emitted.

The term “vacuum ultraviolet radiation” below also refers to electromagnetic radiation with a maximum emission in a wavelength range between 145 and 185 nm.

In a typical construction for the gas discharge lamp, this consists of a cylindrical glass lamp bulb filled with xenon, on the wall of which on the outside is arranged a pair of strip-like electrodes which are electrically insulated from each other. The strip-like electrodes extend over the entire length of the lamp bulb, where their long sides lie opposite each other leaving two gaps. The electrodes are connected to the poles of a high voltage source operated with an alternating voltage of the order of 20 kHz to 500 kHz, such that an electric discharge forms only in the area of the inner surface of the lamp bulb.

When an alternating voltage is applied to the electrodes, in the xenon containing filler gas a corona discharge can be ignited. As a result, in the xenon are formed excimers, i.e. molecules that consist of an excited xenon atom and a xenon atom in the basic state
Xe+X*=Xe₂*.

The excitation energy is emitted again as VUV radiation with a wavelength of X=170 to 190 nm. This conversion from electron energy into UV radiation is highly efficient. The generated VUV photons are absorbed by the phosphors of the phosphor layer and the excitation energy is partly emitted again in the longer wavelength range of the spectrum.

In principle, for the discharge vessel a multiplicity of forms are possible, such as plates, single tubes, coaxial tubes, straight, U-shaped, circularly curved or coiled, cylindrical or other shape discharge tubes.

As a material for the discharge vessel quartz or glass types are used.

The electrodes consist of a metal, for example aluminum or silver, a metal alloy or a transparent conductive inorganic compound, for example ITO. They can be formed as a coating, an adhesive foil, a wire or a wire mesh.

The discharge vessel is filled with a gas mixture containing an inert gas such as xenon, krypton, neon or helium. Gas fillings, which mainly consist of oxygen-free xenon having a low gas pressure, for example 2 Torr are preferred. The gas filling can also contain a small quantity of mercury in order to maintain a low gas pressure during discharge.

The inner wall of the gas discharge vessel is coated partly or fully with a phosphor coating, which contains one or more phosphors or phosphor preparations. The phosphor layer can also contain organic or inorganic binding agents or a binding agent combination.

The phosphor coating is preferably applied to the inner wall of the gas discharge vessel as a substrate and can comprise a single phosphor layer or several phosphor layers, in particular double layers of a base and a cover layer.

A phosphor coating with a base and a cover layer allows the quantity of down-conversion phosphor in the cover layer to be reduced and in the base layer a less costly phosphor to be used. The base layer preferably contains as a phosphor a calcium halophosphate phosphor selected so as to achieve the desired shade of the lamp.

The cover layer contains the down-conversion phosphor, which thus converts an essential part of the VUV radiation generated by the gas discharge directly into the desired radiation in the visible range.

An important characteristic of the down-conversion phosphor in accordance with the invention resides in that it comprises a pair of activators of a first and a second lanthanoid ion and a sensitizer in a host lattice, wherein the sensitizer is selected from the group formed by the thallium(I) ion and lead(II) ion, and occupies a crystallographic site with a coordination number C.N.≧10.

Preferably the first lanthanoid ion is the gadolinium(III) ion and the second lanthanoid ion is selected from the holmium(III) ion and the europium(III) ion.

In a phosphor according to the present invention any halogen or mixture of halogens can be used as anions. In a preferred embodiment of the invention fluorides are used.

Suitable host lattices for the formation of phosphors include a) perovskite related structures, b) elpasolites and c) ternary gadolinium fluorides of the MGd₂F₇-type.

a) The general formula of the perovskite related structure, useful according to the present invention, is M′M″GdF6 with M′=Li, Na, K, Rb, Cs, Cu, Ag and M″=Be, Mg, Ca, Sr, Ba, Zn.

The chemical constitution of the ideal perovskite structure can be represented by the general formula ABX₃. The perovskite structure is built up of cubes consisting of three chemical elements A, B and X in a ratio of 1:1:3, respectively. The A and B atoms are incorporated as cations, the X atoms, usually fluorine, as anions. The size of the A cation is always comparable to that of fluorine, whereas the B cation is much smaller. The valency of the individual cations may vary, provided that the sum of the cation valencies counterbalances the charge of the three anions.

In the ideal, undistorted perovskite structure the anions and the A cations form a cubical closest packing, so that the A site is surrounded by 12 anions and the coordination number C.N. equals 12.

The B cations occupy the octahedral vacancies in the lattice that are formed only by 6 anions.

Variations in the composition of the perovskites lead to the formation of more or less distorted, perovskite structures whose symmetry is less high.

Variations of the compounds having the perovskite structure are formed in that the A and/or B cations can be partly substituted by one or more other cations, so that the initially ternary perovskites ABX₃ are turned into perovskites having more elements, for example quaternary, quinary, senary, septenary, etc. perovskites.

Examples of cations that may substitute gadolinium on an B site are Ce³⁺, Pr³⁺, Nd³⁺, Sm³⁺, Tb³⁺, Dy³⁺, Ho³⁺, Er³⁺, Tm³⁺, Yb³⁺, Lu³⁺ with a concentration of 0.01 to 30 mol-%,

Al³⁺, Ga³⁺, In³⁺, Sc³⁺, Y³⁺, La³⁺ with a concentration of 0.01 to 90 mol-%.

The perovskite related structure of M′M″GdF₆ having cation vacancies on the B sites with large resulting anisotropic environments are characterized by large crystal field splittings which significantly improve the absorption of VUV-radiation by the ion pairs Gd³⁺—Eu³⁺ and Gd³⁺—Ho³⁺. Large crystal field splittings also result in increased opportunity for internal relaxation mechanisms involving photon generation, which thus far have not been found to be pronounced in comparable but more isotropic media.

b) The general formula of the elpasolites, useful according to the present invention is:

A_{2-y}B_{1+y}Me³⁺X₆, wherein A is a monovalent ion such as Li, Na, K, Rb, Cs, Cu, Ag, B is a monovalent ion such as Li, Na, K, Rb, Cs, Cu, Ag, A is different from B, Me³⁺ is a trivalent ion, preferably gadolinium, X is at least one of F, Cl, Br and I, 0<y<1 and 0<x<0.3.

Examples of cations that may substitute gadolinium on an B site are Ce³⁺, Pr⁺, Nd³⁺, Sm³⁺, Tb³⁺, Dy³⁺, Ho³⁺, Er³⁺, Tm³⁺, Yb³⁺, Lu³⁺ with a concentration of 0.01 to 30 mol-%,

Al³⁺, Ga³⁺, In³⁺, Sc³⁺, Y³⁺, La³⁺ with a concentration of 0.01 to 90 mol-%.

The crystallography of elpasolites is related to the better-known perovskites.

Elpasolites can, depending on the ionic radii of the various ions composing the compound, crystallize in various crystalline systems. Cubic, triclinic and hexagonal elpasolites are known. Elpasolites crystallized in any crystalline system are useful for the present invention.

c) Ternary gadolinium fluorides MGd₂F₇. comprise a host lattice wherein the C.N. of the M-cation is 14. Twelve anions are arranged in a first coordination sphere, two additional anions are arranged in a second coordination sphere.

Due to the high coordination numbers and the non-polar ligands, these host lattices are characterized by a low ligand field for cations, which are part of the host lattice.

While the structural considerations are paramount, the compositions must also contain the requisite ion pairs Gd³⁺—Eu³⁺, Gd³⁺—Ho³⁺ and mixtures thereof. Gadolinium is partly exchanged in the host lattice by Eu³⁺ with a concentration of 0.01 to 30 mol-% or by Ho³⁺ with a concentration of 0.01 to 30 mol-%,

The phosphors doped with the activator pair Gd³⁺—Eu³⁺ or Gd³⁺—Ho³⁺ preferably contain 10 to 99.8 mol % of the trivalent Gd³⁺ and 0.01 to 30 mol %, particularly preferably 1.0 mol % of the trivalent holmium or the trivalent europium.

The pair of activators of a first lanthanoid ion and a second lanthanoid ion and the co-activator ion cooperate in the sequential emission of photons by means of which the phosphor generates more than one visible photon from a UV photon.

Another requirement is the incorporation of a sensitizer in the host lattice on a highly coordinated crystallographic site. The sensitizer atoms absorb the incident photon either directly, or from the host lattice, and transfer it to the activator ion.

The sensitizer is selected from the group formed by the thallium(I) ion and lead(II) ion. In general, these ions are also indicated in accordance with their electron configuration as 6s2 ions.

Tl⁺ or Pb²⁺ are incorporated in the fluoride host lattice on a highly coordinated crystallographic site, preferably on the M′ or M″ site of a perovskite-related type of structure with a composition M′M″GdF₆ and with M′=Li, Na, K, Rb, Cs, Cu, Ag and M″=Be, Mg, Ca, Sr, Ba, Zn and Tl⁺ or Pb²⁺ coordinated by 12 fluoride ions, preferably on the M′ site of an elpasolite type of structure with a composition M′₂M″GdF₆ and with M′=Li, Na, K, Rb, Cs, Cu, Ag and M″=Li, Na, K, Rb, Cs, Cu, Ag and Tl⁺ or Pb²⁺ coordinated by 12 fluoride ions, preferably on the M site of a structure with a composition MGd₂F₇ and with M=Be, Mg, Ca, Sr, Ba, Zn and Tl⁺ or Pb²⁺ coordinated by 14 fluoride ions;

The sensitizer enhances the sensitivity of the down-conversion phosphor to VUV radiation and makes it less wavelength-dependent. The sensitizer has a high intrinsic absorption in the desired VUV range of 100 to 200 nm, which exceeds the intrinsic absorption of the non-sensitized down-conversion phosphors at approximately 183, 195 and 202 nm. The transmission of the excitation energy to the pair of activators is subject to losses because lattice imperfections cause excitation states traversing the lattice to release energy to said lattice in the form of heat oscillations. Next, the reduced, absorbed excitation energy is transferred to the activator and triggers the down-conversion mechanism. This leads to increased luminescence of the down-conversion phosphor as it has been “sensitized” by the sensitizer so as to be able to be luminescent upon exposure to VUV radiation.

The down-conversion phosphor may additionally also comprise a co-activator.

The co-activator is selected from the group of the trivalent ions of terbium, ytterbium, dysprosium and samarium and the bivalent ions of manganese.

The current inventors believe the following possible mechanism of energy transfer utilizing Gd³⁺—Eu³⁺ or Gd³⁺—Ho³⁺ ion pairs together with s² ions, such as Tl(I) or Pb(II) as sensitizers.

The Tl(I) or Pb(II) sensitizers absorb the incident VUV radiation (λ between 100 and 200 nm) and transfer the energy to the Gd³⁺⁶G_{J} states (or to a level higher in energy than ⁶G_{J}) (FIG. 3).

In case of the Gd³⁺—Eu³⁺ ion pair the excitation mechanism can take place by a Gd³⁺⁸S_{7/2}-⁶G_{J} excitation or excitation to a level higher in energy than ⁶G_{J} of the gadolinium(III) ion, after which a cross-relaxation transition Gd³⁺⁶G_{J}-⁶P_{J}/Eu³⁺⁷F₁-⁵D₀ between the gadolinium(III) ion and the europium(III) ion takes place.

Next the europium(III) ion emits a first photon in the visible, the energy of which corresponds to the transition Eu³⁺⁵D₀-⁷F_{J}.

The gadolinium(III) ion then transfers the energy to another europium(III) ion in the sublattice by a Gd³⁺⁶P_{J}—⁸S_{7/2}/Eu³⁺⁷F₁-⁵D_{J} transfer and a Eu³⁺⁵D_{J}-⁷F_{J} emission generates a second photon in the visible.

In case of Gd³⁺—Ho³⁺ ion pair the excitation mechanism can take place by a Gd³⁺⁸S_{7/2}-⁶G_{J} excitation or excitation to a level higher in energy than ⁶G_{J} of the gadolinium(III) ion, after which a cross-relaxation transition Gd³⁺⁶G_{J}-⁶P_{J}/Ho³⁺⁵I₈—⁵F₅ between the gadolinium(III) ion and the holmium(III) ion takes place.

Next the holmium(III) ion emits a first photon in the visible, the energy of which corresponds to the transition Ho³⁺⁵F₅—⁵I₈.

The gadolinium(III) ion then transfers the energy to another europium(III) ion in the sublattice by a Gd³⁺⁶P_{J}—⁸S_{7/2}/Eu³⁺⁷F₁-⁵D_{J} transfer and a Eu³⁺⁵D_{J}-⁷F_{J} emission generates a second photon in the visible.

After energy transfer of the Gd³⁺⁶P_{J}—⁸S_{7/2} state of the gadolinium(III) ion to a co activator, the emission of the coactivator generating a second photon in the visible.

The emission of two photons in the visible per absorbed VUV photon leading to a down-conversion efficiency between 100 and 200%.

This quantum cutter concept is an improvement with regard to a state of the art quantum cutter concept based on interacting rare-earth ions, namely Gd³⁺—Eu³⁺ (FIG. 1) and Gd³⁺—Ho³⁺ (FIG. 2). Typical compounds with the ion couple incorporated are, for instance, LiGdF₄:Eu or LiGdF₄:Ho, Tb. For these state of the art materials down-conversion efficiencies up to 200% are experimentally proven. However, in view of a technical application up to now the materials suffer from the fact that on one hand their absorption in the VUV is quite low. As a result most of the incoming light is reflected. Moreover, due to the special energy transfer mechanism starting with ⁸S_{7/2}-⁶G_{J} transition on Gd³⁺, the absorption is limited to three narrow lines at 183, 195 and 202 nm. All of these lines do not correlate with the maximum of the emission band of the Xe-discharge at 172 nm. In accordance with this situation no down-conversion occurs at 160 to 180 nm excitation. At 202 nm excitation till now quantum efficiency only reaches about 70% and light output about 30%. It should be mentioned explicitly that this is with the down-conversion effect included.

The absorption coefficients of the sensitized down-conversion phosphors in accordance with the invention are particularly large for the wavelengths in the range of xenon radiation, and the quantum efficiency levels are high. The host lattice is not involved in the luminescence process but influences the precise position of the energy levels of the activator ions and the sensitizer ions and consequently the wavelengths of absorption and emission.

The emission bands lie in the range from near UV to yellow-orange, but predominantly in the red and green range of the electromagnetic spectrum. The extinction temperature of these phosphors is above 100° C.

The grain size of the phosphor particles is not critical. Normally, the phosphors are used as fine grain powders with a grain-size distribution between 1 and 20 um.

As production processes for a phosphor layer on a wall of the discharge vessel, both dry coating processes, for example electrostatic deposition or electrostatically supported sputtering, and wet coating processes, for example dip coating or spraying, can be considered. For wet coating processes, the phosphor preparation must be dispersed in water, an organic solvent, where applicable together with a dispersion agent, a tenside and an anti-foaming agent or a binding agent preparation. Suitable binding agent preparations for a gas discharge lamp according to the invention are organic or inorganic binding agents, which are capable of withstanding an operating temperature of 250° C. without destruction, embrittlement or discoloration.

For example, the phosphor preparation can be applied to a wall of the discharge vessel by means of a flow coating process. The coating suspensions for the flow coating process contain water or an organic compound such as butyl acetate as the solvent. The suspension is stabilized and its rheological properties influenced by the addition of; auxiliary agents such as stabilizers, liquefiers, cellulose derivatives. The phosphor suspension I is applied to the vessel walls as a thin layer, dried and burnt in at 600° C.

It can also be preferred that the phosphor preparation for the phosphor layer is deposited electrostatically on the inside of the discharge vessel.

For a gas discharge lamp which is to emit white light, preferably a blue emitting phosphor from the group BaMgAl₁₀O₁₇:Eu²⁺ and Sr₅(PO₄)₃Cl:Eu²⁺ is combined with a red-emitting phosphor from the group RbGd₂F₇:Eu, Tl; KMgF₃:Gd, Eu, Pb; BaGd₂F₇:Eu, Pb; KGd₂F₇:Eu, Bi and with a green-emitting phosphor from the group (Y, Gd)BO₃:Tb and LaPO₄:Ce, Tb or with a green-red phosphor such as LiGdF₄:Ho, Tb, Tl. The phosphor layer usually has a layer thickness of 5 to 100 μm.

The vessel is then evacuated to remove all gaseous contaminants, in particular oxygen. The vessel is then filled with xenon and sealed.

### EXAMPLE 1

A cylindrical discharge vessel of glass having a length of 590 mm, a diameter of 24 mm and a wall thickness of 0.8 mm is filled with xenon at a pressure of 200 hPa. The discharge vessel contains an axis-parallel inner electrode in the form of a noble metal rod of 2.2 mm diameter. On the outside of the discharge vessel is the outer electrode composed of two strips of conductive silver 2 mm in width arranged axis-parallel and conductively connected to the power supply. The lamp is operated by means of a pulsed DC voltage.

The inner wall of the discharge vessel is coated with a phosphor layer.

The phosphor layer contains a three-band phosphor mixture with the following components: BaMgAl₁₀O₁₇:Eu²⁺ as the blue component, LaPO₄:Ce, Tb as the green component and KSrdF₆:Eu, Tl as the red component.

To produce KSrGdF₆:Eu, Tl with 1.0 mol % europium and 0.1 mol % thallium, 49.50 g GdF₃, 13.55 g KF, 29.44 g SrF₂, 0.49 g EuF₃ and 0.52 g TlF are thoroughly mixed and ground in an agate mortar. The mixture is prefired in a corundum crucible in a quartz tube under vacuum at a pressure of 8 10⁻² Pa for 2 hours at 300° C. During firing, the quartz tube was rinsed with argon three times and evacuated again to 8 10⁻² Pa. The oven temperature was then increased at a rate of 5.5° C./min to 750° C. and the mixture sintered for 8 hours at 750° C. The sintered powder was reground and sieved to a grain size 40 μm. The crystal structure of the formed phase was checked by means of X-ray diffractometry.

In this manner, a light output of initially 37 lm/W was achieved. After 1000 h operating hours, the light output was approximately 34 lmW. The quantum efficiency for VUV-light is approximately 70%.

### EXAMPLE 2

A cylindrical discharge vessel of glass having a length of 590 mm, a diameter of 24 mm and a wall thickness of 0.8 mm is filled with xenon at a pressure of 200 hPa. The discharge vessel contains an axis-parallel inner electrode in the form of a noble metal rod of 2.2 mm diameter. On the outside of the discharge vessel is the outer electrode composed of two strips of conductive silver 2 mm in width arranged axis-parallel and conductively connected to the power supply. The lamp is operated by means of a pulsed DC voltage.

The inner wall of the discharge vessel is coated with a phosphor layer.

The phosphor layer contains a three-band phosphor mixture with the following components: BaMgAl₁₀O₁₇:Eu²⁺ as the blue component and CsBaGdF₆:Ho, Tb, Pb with Ho(1.0 mol-%), Tb(1.0 mol-%), Pb(1.0 mol-%) as the green-red component.

To produce CsBaGdF₆:Ho, Tb, Pb with 1.0 mol-% holmium, 1.0 mol-% terbium and 1.0 mol-% lead, a quantity of 49.00 g GdF₃, 35.51 g CsF, 40.89 g BaF₂, 0.52 g HoF₃, 0.50 g TbF₃ and 0.57 g PbF₂ are thoroughly mixed and ground in an agate mortar. The mixture is prefired in a corundum crucible in a quartz tube under vacuum at a pressure of 8 10⁻² Pa for 2 hours at 300° C. During firing, the quartz tube was rinsed with argon three times and evacuated again to 8 10⁻² Pa. The oven temperature was then increased at a rate of 5.5° C./min to 750° C. and the mixture sintered for 8 hours at 750° C. The sintered powder was reground and sieved to a grain size 40 μm. The crystal structure of the formed phase was checked by means of X-ray diffractometry.

In this manner, a light output of initially 37 lm/W was achieved. After 1000 h operating hours, the light output was approximately 34 lm/W. The quantum efficiency for VUV-light is approximately 70%.

### EXAMPLE 3

A cylindrical discharge vessel of glass having a length of 590 mm, a diameter of 24 mm and a wall thickness of 0.8 mm is filled with xenon at a pressure of 200 hPa. The discharge vessel contains an axis-parallel inner electrode in the form of a noble metal rod of 2.2 mm diameter. On the outside of the discharge vessel is the outer electrode composed of two strips of conductive silver 2 mm in width arranged axis-parallel and conductively connected to the power supply. The lamp is operated by means of a pulsed DC voltage.

The inner wall of the discharge vessel is coated with a phosphor layer.

The phosphor layer contains a three-band phosphor mixture with the following components: BaMgAl₁₀O₁₇:Eu²⁺ as the blue component, LaPO₄:Ce, Tb as the green component and Rb₂NaGdF₆: Eu, Pb with 1.0 mol-% europium and 1.0 mol-% lead as the red component.

To produce Rb₂NaGdF₆: Eu, Pb with 1.0 mol-% europium and 1.0 mol-% lead, a quantity of 49.50 g GdF³, 48.60 g RbF, 9.81 g NaF, 0.49 g EuF₃ and 0.57 g PbF₂ are thoroughly mixed and ground in an agate mortar. The mixture is prefired in a corundum crucible in a quartz tube under vacuum at a pressure of 8 10⁻² Pa for 2 hours at 300° C. During firing, the quartz tube was rinsed with argon three times and evacuated again to 8 10⁻² Pa. The oven temperature was then increased at a rate of 5.5° C./min to 750° C. and the mixture sintered for 8 hours at 750° C. The sintered powder was reground and sieved to a grain size 40 μm. The crystal structure of the formed phase was checked by means of X-ray diffractometry.

In this manner, a light output of initially 37 lm/W was achieved. After 1000 h operating hours, the light output was approximately 34 lm/W. The quantum efficiency for VUV-light is approximately 70%.

### EXAMPLE 4

A cylindrical discharge vessel of glass having a length of 590 mm, a diameter of 24 mm and a wall thickness of 0.8 mm is filled with xenon at a pressure of 200 hPa. The discharge vessel contains an axis-parallel inner electrode in the form of a noble metal rod of 2.2 mm diameter. On the outside of the discharge vessel is the outer electrode composed of two strips of conductive silver 2 nm in width arranged axis-parallel and conductively connected to the power supply. The lamp is operated by means of a pulsed DC voltage.

The inner wall of the discharge vessel is coated with a phosphor layer.

The phosphor layer contains a three-band phosphor mixture with the following components: BaMgAl₁₀O₁₇:Eu²⁺ as the blue component, LaPO₄:Ce, Tb as the green component and BaGd₂F₈:Eu, Pb with 1.0 mol-% europium and 1.0 mol-% lead as the red component.

To produce BaGd₂F₈:Eu, Pb with 1.0 mol-% europium and 1.0 mol-% lead, a quantity of 49.50 g GdF₃, 20.44 g BaF₂, 0.49 g EuF₃ and 0.28 g PbF₂ are thoroughly mixed and ground in an agate mortar. The mixture is prefired in a corundum crucible in a quartz tube under vacuum at a pressure of 8 10⁻² Pa for 2 hours at 300° C. During firing, the quartz tube was rinsed with argon three times and evacuated again to 8 10⁻² Pa. The oven temperature was then increased at a rate of 5.5° C./min to 750° C. and the mixture sintered for 8 hours at 750° C. The sintered powder was reground and sieved to a grain size 40 μm. The crystal structure of the formed phase was checked by means of X-ray diffractometry.

In this manner, a light output of initially 37 lm/W was achieved. After 1000 h operating hours, the light output was approximately 34 lm/W. The quantum efficiency for VUV-light is approximately 70%.

### EXAMPLE 5

A cylindrical discharge vessel of glass having a length of 590 mm, a diameter of 24 mm and a wall thickness of 0.8 mm is filled with xenon at a pressure of 200 hPa. The discharge vessel contains an axis-parallel inner electrode in the form of a noble metal rod of 2.2 mm diameter. On the outside of the discharge vessel is the outer electrode composed of two strips of conductive silver 2 mm in width arranged axis-parallel and conductively connected to the power supply. The lamp is operated by means of a pulsed DC voltage.

The inner wall of the discharge vessel is coated with a phosphor layer.

The phosphor layer contains a three-band phosphor mixture with the following components: BaMgAl₁₀O₁₇:Eu²⁺ as the blue component, LaPO₄:Ce, Tb as the green component and Cs₂KGdF₆:Eu, Tl with 1.0 mol-% europium and 1.0 mol-% thallium as the red component.

To produce Cs₂KGdF₆:Eu, Tl with 1.0 mol-% europium and 1.0 mol-% thallium a quantity of 49.50 g GdF₃, 71.03 g CsF, 13.55 g KF, 0.49 g EuF₃ and 0.52 g TlF are thoroughly mixed and ground in an agate mortar. The mixture is prefired in a corundum crucible in a quartz tube under vacuum at a pressure of 8 10⁻² Pa for 2 hours at 300° C. During firing, the quartz tube was rinsed with argon three times and evacuated again to 8 10⁻² Pa. The oven temperature was then increased at a rate of 5.5° C./min to 750° C. and the mixture sintered for 8 hours at 750° C. The sintered powder was reground and sieved to a grain size 40 μm. The crystal structure of the formed phase was checked by means of X-ray diffractometry.

In this manner, a light output of initially 37 lm/W was achieved. After 1000 h operating hours, the light output was approximately 34 lm/W. The quantum efficiency for VUV-light is approximately 70%.

1. A gas discharge lamp fitted with a gas discharge vessel filled with a gas filling suitable for supporting a gas discharge emitting VUV radiation, with a phosphor coating containing a down-conversion phosphor, and with means for igniting and maintaining a gas discharge, in which the down-conversion phosphor comprises in a host lattice with crystallographic sites a pair of activators of a first lanthanoid ion and a second lanthanoid ion and a sensitizer, selected from the group formed by the thallium(I) ion and lead(II) ion, wherein the sensitizer occupies a crystallographic site with a coordination number C.N.≧10.

2. A gas discharge lamp as claimed in claim 1, characterized in that the first lanthanoid ion is the gadolinium(III) ion and the second lanthanoid ion is selected from the holmium(III) ion and the europium(III) ion.

3. A gas discharge lamp as claimed in claim 1, characterized in that the host lattice of the down-conversion phosphor is a fluoride.

4. A gas discharge lamp as claimed in claim 1, characterized in that the host lattice of the down-conversion phosphor is a perovskite.

5. A gas discharge lamp as claimed in claim 1, characterized in that the host lattice of the down-conversion phosphor is an elpasolite.

6. A gas discharge lamp as claimed in claim 1, characterized in that the down-conversion phosphor comprises the gadolinium(III) ion as the first lanthanoid ion and, as the second lanthanoid ion, the holmium(III) ion or the europium(III) ion and a co-activator selected from the group formed by the terbium(III) ion, ytterbium(III) ion, dysprosium(III) ion, europium(III) ion, samarium(II) ion and manganese(II) ion.

7. A gas discharge lamp as claimed in claim 1, characterized in that the down-conversion phosphor contains the first lanthanoid ion in a concentration of 10.0 to 99.98 mol %, the second lanthanoid ion in a concentration of 0.01 to 30.0 mol % and the sensitizer in a concentration of 0.01 to 30.0 mol %.

8. A gas discharge lamp as claimed in claim 1, characterized in that the down-conversion phosphor contains the sensitizer in a concentration of 0.5 mol %.

9. A gas discharge lamp as claimed in claim 1, characterized in that the down-conversion phosphor contains the co-activator in a concentration of 0.01 to 30.0 mol %.

10. A down-conversion phosphor which contains, in a host lattice with crystallographic sites, a pair of activators of a first lanthanoid ion and a second lanthanoid ion, and a sensitizer selected from the group formed by the thallium(I) ion and lead(II) ion, wherein the sensitizer occupies a crystallographic site with a coordination number C.N.≧10.
